(19) United States
(12) Patent Application Publication
(10) Pub. No.: US 2005/0281134 A1
(43) Pub. Date: Dec. 22, 2005

(54) Method and apparatus for pulse-by-pulse calibration of a pulse-echo ranging system

(76) Inventor: Edson Leocadio Ferreira, Peterborough (CA)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/870,633

(22) Filed: Jun. 17, 2004

(51) Int. Cl. G01S 15/88

(52) U.S. Cl. 367/99; 367/902; 367/908

(57) ABSTRACT

A level measurement or time of flight ranging apparatus for determining a distance measurement to the surface of a material. The apparatus comprises a transducer, a transmitter, a receiver and a processor. In response to the transmitter, the transducer emits energy pulses towards the surface of the material. The transducer detects pulses reflected by the material surface and the receiver converts the reflected pulses into signals for further processing by the processor. The apparatus further includes a mechanism for reflecting a reference pulse from a known distance with respect to the transducer. The processor determines a ratio between the reference distance (or reference pulse time of travel) and the reflected pulse(s) (or reflected pulse time of travel). The ratio is used with the reference distance to determine the distance measurement to the surface of the material.

### FIELD OF THE INVENTION

The present invention relates to time-of-flight ranging or pulse-echo ranging systems and, in particular, to a method and apparatus for calibrating and improving the accuracy of pulse-echo ranging systems.

### BACKGROUND OF THE INVENTION

Pulse-echo acoustic ranging systems, also known as time-of-flight ranging systems, are commonly used in level measurement applications. Pulse-echo acoustic ranging systems determine the distance to a target or reflector (i.e. reflective surface) by measuring how long after transmission of a burst of energy pulses the echo or reflected pulses are received. Such systems typically use ultrasonic pulses or pulse radar signals.

Pulse-echo acoustic ranging systems generally include a transducer and a signal processor. The transducer serves the dual role of transmitting and receiving the energy pulses. The signal processor is for detecting and calculating the distance or range of the object based on the transmit times of the transmitted and reflected energy pulses.

Since the transmitted energy pulses are converted into distance measurements, any timing errors arising in the circuitry of the device result in distance measurement errors which degrade the accuracy of the level measurements. In most cases, errors arise due to temperature changes or temperature effects. Timing errors are a result of temperature drift and drift over time in the operating characteristics of the electronics in the device circuitry. It is necessary to re-tune or recalibrate time-of-flight ranging systems not only at installation, but on a periodic basis as well in order to ensure accurate level measurements.

Temperature changes also give rise to speed errors in the transmission and reception of the energy pulses. The velocity of the energy pulses depends on the temperature, the type of medium, and the pressure (i.e. in the vessel). The type of medium and pressure is typically not compensated, as the temperature variation is generally the dominant variable. As a result, the temperature in the medium where the ultrasonic waves (pulses) propagate for level measurements needs to be accurately measured and compensated, if necessary, to maintain precision of the distances being measured. Known approaches involve measuring or monitoring the temperature in the transducer and taking this as the temperature for the medium and the basis for propagation speed compensation based on temperature.

There however remains a need to provide a system and techniques which facilitate calibrating pulse-echo or time-of-flight ranging systems while accounting for the effects of temperature in the propagation medium.

### SUMMARY OF THE INVENTION

The present invention provides a method and apparatus for calibrating a pulse-echo ranging system.

According to one aspect, the present invention utilizes a distance reference. The reference distance is incorporated in the echo profile so that the distance to be measured becomes relative to the reference distance. In one embodiment, the distance reference is provided by apparatus which echoes back a portion of the energy emitted by the transducer, and the echoed energy is from a known distance. The echo processing module determines a ratio between the distance reference and the distance to be measured (i.e. distance to a target), or the time measurements for the pulses reflected by a reference surface and the time measurements for the pulses reflected by the target surface. The measured distance is then determined from the ratio and the reference distance.

In one aspect, the present invention provides a level measurement apparatus for measuring a distance to a material having a surface, the level measurement apparatus comprises: a transducer for emitting energy pulses and detecting energy pulses reflected by the surface of the material; a controller having a receiver and a transmitter; the transducer being operatively coupled to the transmitter and responsive to the transmitter for emitting the energy pulses, and the transducer being operatively coupled to the receiver for outputting reflected energy pulses coupled by the transducer; the receiver including a converter for converting the reflected energy pulses into signals; the controller including a program component for generating an echo profile based on the signals; the controller including another program component for adding a reference echo pulse to the echo profile, the reference echo pulse being derived from a reflection at a known distance; the controller including another program component for determining a ratio based on the reference echo pulse and another one of the pulses in the echo profile; and the controller including another program component for calculating the distance to the surface of material based on the ratio and the known distance.

In another aspect, the present invention provides a method for a level measurement instrument for determining a distance measurement to a target surface, the method comprises the steps of: emitting one or more pulses towards the target surface; receiving reflected pulses from said target surface, and determining a first measured parameter for at least one of said reflected pulses; receiving one or more pulses reflected by a reference surface, and determining a second measured parameter for at least one of said reflected reference pulses; forming a ratio between said first measured parameter for said reflected pulses and said second measured parameter for said reflected reference pulses; determining a distance measurement to said reference surface; determining the distance measurement to the target surface based on said ratio and said distance measurement to said reference surface.

In a further aspect, the present invention provides an apparatus for performing level measurements of a material contained a vessel and having a surface, the apparatus comprises: a transducer for emitting pulses towards to the surface of the material contained in the vessel and detecting echo pulses reflected by the surface of the material; a transmitter coupled to the transducer, the transmitter being responsive to transmit control signals for controlling emission of pulses from the transducer; a receiver coupled to the transducer, the receiver converting the reflected pulses received by the transducer into electrical signals corresponding to the received reflected pulses; a controller, the controller being operatively coupled to the transmitter and having a program component for generating the transmit control signals, and the controller being operatively coupled to the receiver and having a program component for receiving and processing the electrical signals from the receiver; a reference reflector, the reference reflector being positioned to reflect one or more of the emitted pulses back to the transducer to provide one or more reference pulses, and the reference reflector being located at a known distance from the transducer; the controller including a program component for determining a measured parameter associated with one or more of the echo pulses and for determining another measured parameter associated with one or more of the reference pulses, and a program component for determining a ratio comprising the measured parameters; the controller including a program component for determining a distance measurement to the surface of the material based on the ratio and the known distance to said reference reflector

In yet another aspect, the present invention provides a level measurement apparatus for determining a distance measurement to a surface, the apparatus comprises: means for emitting one or more pulses towards the surface; means for receiving reflected pulses from the surface, and means for determining a first measured parameter for at least one of said reflected pulses; means for receiving one or more pulses reflected by a reference surface means, and means for determining a second measured parameter for at least one of said reflected reference pulses; means for forming a ratio between said first measured parameter for said reflected pulses and said second measured parameter for said reflected reference pulses; means for determining a distance measurement to said reference surface means; means for calculating the distance measurement to the surface based on said ratio and said distance measurement to said reference surface.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows a block diagram of an embodiment of a pulse-echo ranging system in accordance with the present invention;

FIG. 2 shows in diagrammatic form a mechanical apparatus in accordance with one embodiment for generating a reference distance for echo processing;

FIG. 3 shows, in diagrammatic form, an echo profile with a reference distance echo for determining distance to a target in accordance with the present invention.

Similar reference numerals are used in different figures to denote similar components.

### DESCRIPTION OF THE EMBODIMENTS

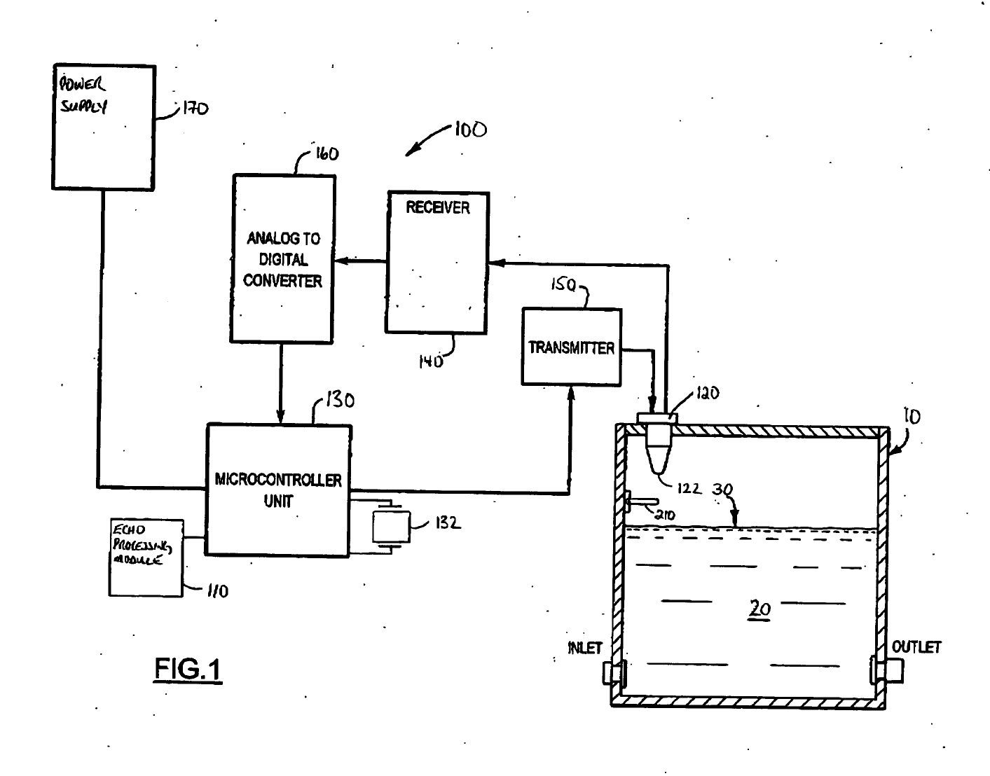

Reference is first made to FIG. 1, which shows a pulse-echo level measurement system 100 in accordance with the present invention.

As shown in FIG. 1, the pulse-echo level measurement system 100 is installed in a vessel 10, e.g. a storage tank, containing a material 20, for example, a liquid, sludge or granular material, having a level determined by the top surface of the material 20. The top surface of the material 20 provides a reflective surface or reflector, indicated by reference 30, which reflects pulses (e.g. ultrasonic pulses or radar energy bursts emitted by a transducer).

The pulse-echo level measurement system 100 includes an echo processing module 110, a transducer 120, a controller or signal processor unit 130, a receiver module 140, a transmitter module 150, an analog-to-digital (A/D) converter 160 and a power supply unit 170. In other implementations, the power supply 170 may be replaced by a loop powered interface (not shown). The controller 130, for example a microprocessor, includes an oscillator 132 for establishing an accurate sampling time base. As will be described in more detail below, the echo processing module 110 incorporates a reference distance determination which is used to calculate the distance to the surface 30 of the material contained in the vessel or tank 10. The echo processing module 110 may be implemented as a component of the firmware or software executed by the controller 130,

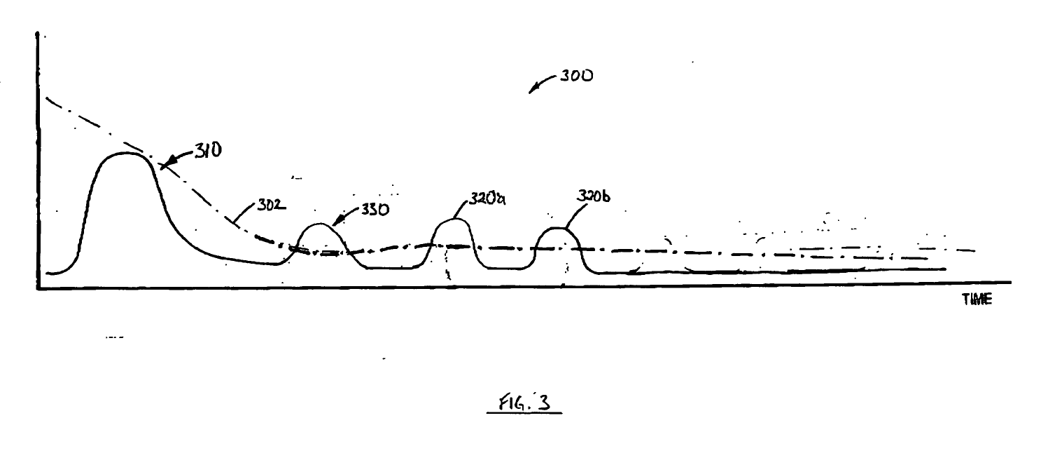

The transducer 120 is responsive to signals applied to the transmitter module 150 by the controller 130 and emits a transmit pulse or energy burst directed at to the surface 30 of the material 20 to be measured. The surface 30 reflects the transmit energy burst and the reflected energy pulses are coupled by the transducer 120 and converted into electrical signals. The electrical signals are applied to the receiver 140 and sampled and digitized by the A/D converter 160. The signal processor 130, for example a microprocessor operating under firmware control, takes the digitized output and executes an algorithm which identifies and verifies the echo pulses and generates the echo profile 300 having a form as shown in FIG. 3. In known manner, the signal processor 130 executes an algorithm which uses the echo profile 300 to calculate the range, i.e. the distance to the reflective surface, from the time it takes for the reflected energy pulse to travel from the reflective surface to the transducer 120. From this calculation, the distance to the surface of the liquid and thereby the level of the liquid is determined. The controller or signal processor 130 is implemented using a microprocessor or microcontroller, which is suitably programmed to perform these operations as will be within the understanding of those skilled in the art The method and processing steps as described below may also be embodied in the controller as a program component or firmware.

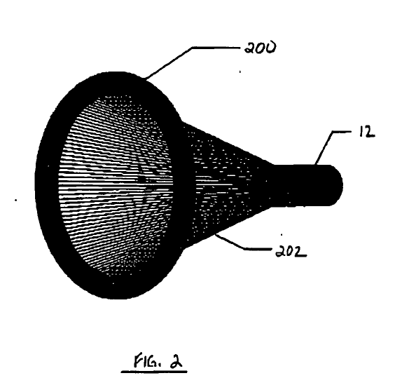

Referring to FIG. 1, the pulse echo level measurement system 100 includes a mechanical apparatus for reflecting energy pulses transmitted by the transducer 120. The primary function of Fe mechanical apparatus is to generate a reference distance for the echo processing module 110. According to one embodiment, the mechanical apparatus is implemented as a reflecting ring 200 as shown in FIG. 2. The reflecting ring 200 reflects a portion of the pulses emitted by the transducer 120 back to the transducer 120. The reflecting ring 200 is positioned at a known distance so that the reflected pulses are converted into a reference distance by the echo processing module 110. The reflecting ring 200 may be angled to concentrate the reflected pulses back to the emitting source, i.e. the transducer 120. The reflecting ring 200 may include a cone 202 to hold the reflecting ring 200 without blocking the ring reflected wave or pulse.

The echo processing module 110 comprises one or more functions implemented in software or firmware which are executed by the microcontroller 130 to determine the time of flight or level measurements. The received echo pulses are converted into receive signals which are processed by the echo processing module 110 into the echo profile 300 as shown in FIG. 3. The echo profile 300 comprises a half pulse 310 which corresponds to the ring down in the transducer 120 (FIG. 1). The ring down corresponds to the period in which the transducer 120 is still ringing down from the transmit pulses emitted and as such it is very difficult to detect reflected energy pulses. Following the ring down 310, the echo profile 300 comprises a number of pulses 320, indicated individually as 320a and 320b. The pulses 320a and 320b are identified as valid receive echo pulses, for example, by using a time varying threshold or TVT curve 302. The TVT curve 302 provides a baseline or line on the echo profile 300 which is above the noise level in the echo profile 300. Valid echoes appear above the TVT curve 302. Various algorithms and techniques are known in the art for the generating the TVT curve 302. The ring down period 310 also falls underneath the TVT curve 302 and is treated as noise.

The echo processing module 110 processes the echo profile 300 which also includes an embedded distance reference corresponding to the reflection from the reflecting ring 200 (FIG. 2). The distance reference appears as a pulse indicated generally by reference 330. Since the distance to the reflecting ring 200 (FIG. 2) is at a known distance, the distance reference pulse 330 also represents a known distance on the echo profile 300. According to this aspect, the echo processing module 110 includes a function or routine which determines a ratio for the reference distance 330 and the distance to the target (i.e. corresponding to echo pulse 320a). The echo processing module 110 includes another function or routine which determines the distance to the target using the ratio as follows:
D_{TARGET}=D_{REF}*(T_{TARGET}/T_{REF})
Where:
D_{TARGET} is the distance from the transducer emitter to the target surface.
D_{REF} is the distance to the external reference (e.g. reflecting ring) which is precisely known.
T_{TARGET} is the time measured between the transmission and reception of the pulse(s) reflected by the target (i.e. reflective surface being measured).
T_{REF} is the time measured between the transmission and reception of the pulse(s) reflected by the reference surface (e.g. the external reflecting ring 200 of FIG. 2).

Using the above equation, the distance being measured to the target or reflective surface is independent of the speed of the pulses. This in turn means that errors arising from temperature, medium type and pressure inside the vessel associated with the velocity of the pulses do not affect the measurement determinations.

In a further aspect, the distance determination as provided above minimizes or eliminates errors arising from variations in the time or sampling reference due temperature or age effects. For example, if the oscillator crystal 132 (FIG. 1) used for the time reference for the sampling operations runs 10% faster (due to a temperature variation), then both time measurements, T_{TARGET} and T_{REF}, will be out by 10%, but the error is cancelled because the ratio between the two remains the same.

Furthermore, by using the same process or algorithm in the echo processing module 110 to extract the time values for T_{TARGET} and T_{REF}, any error introduced during execution of the code by the microcontroller 130 may be similarly cancelled or at least minimized.

It will be appreciated that by measuring the time for both the pulses (e.g. the reference pulse 330) reflected by the reflecting ring 200 and the echo pulses (e.g. pulse 320) reflected by the target and using the same echo profile (e.g. the echo profile 300 in FIG. 3), the echo processing module 110 makes it possible to provide pulse-by-pulse calibration for the pulse echo level measurement system 100.

While the pulse echo level measurement system 100 comprises an ultrasonic or sound pulse based system, the mechanism and techniques described above are also suitable for electromagnetic wave or radar based systems. In a radar based level measurement or time-of-flight ranging system, the distance to a target or reflective surface is determined according to the following equation:

In a radar based system, the echo processing module 110 includes a function or routine which determines the distance to the target using the ratio as follows:
D_{TARGET}=D_{REF}*(T_{TARGET}/T_{REF})
Where:
D_{TARGET} is the distance from the electromagnetic emitting antenna to the target surface that reflects the electromagnetic wave.
D_{REF} is the distance to the external reference (e.g. reflecting ring) which is precisely known.
T_{TARGET} is the time measured between the emission and capture of the electromagnetic wave reflected by the target (i.e. reflective surface being measured).
T_{REF} is the time measured between the emission and the capture of the electromagnetic wave reflected by the reference surface (e.g. the external reflecting ring 200 of FIG. 2).
   As described above, the determination of distance to the target is independent of the speed that the electromagnetic wave (radar) travels, and furthermore, errors in the time determinations will be offset or cancelled.

Instead of the reflecting ring 200 as shown in FIG. 2, other configurations are possible for the mechanical apparatus defining a reflecting surface for generating a reference distance. For example, a reflector placed and affixed to a wall of the vessel 10 as indicated by reference 210 in FIG. 1.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

1. A level measurement apparatus for measuring a distance to a material having a surface, said level measurement apparatus comprising:
a transducer for emitting energy pulses and detecting energy pulses reflected by the surface of the material;
a controller having a receiver and a transmitter;
said transducer being operatively coupled to said transmitter and responsive to said transmitter for emitting said energy pulses, and said transducer being operatively coupled to said receiver for outputting reflected energy pulses coupled by the transducer;
said receiver including a converter for converting said reflected energy pulses into signals;
said controller including a program component for generating an echo profile based on said signals;
said controller including another program component for adding a reference echo pulse to said echo profile, said reference echo pulse being derived from a reflection at a known distance;
said controller including another program component for determining a ratio based on said reference echo pulse and another one of the pulses in said echo profile; and
said controller including another program component for calculating the distance to the surface of material based on said ratio and said known distance.

2. The level measurement apparatus as claimed in claim 1, wherein said reference echo pulse is reflected by a reflecting surface mounted at a known distance from said transducer.

3. The level measurement apparatus as claimed in claim 2, wherein said reflecting surface comprises a reflecting ring, said reflecting ring being oriented to reflect a portion of the emitted energy pulses from said transducer.

4. The level measurement apparatus as claimed in claim 1, wherein said reference echo pulse is determined from an echo pulse received at the end of the transducer.

5. The level measurement apparatus as claimed in claim 2, wherein said ratio comprises a time of flight for said reflected energy pulse and a time of flight for said reference echo pulse.

6. A method for a level measurement instrument for determining a distance measurement to a target surface, said method comprising the steps of:
emitting one or more bursts of energy towards the target surface;
receiving reflected pulses from said target surface, and determining a first measured parameter for at least one of said reflected pulses;
receiving one or more pulses reflected by a reference surface, and determining a second measured parameter for at least one of said reflected reference pulses;
forming a ratio between said first measured parameter for said reflected pulses and said second measured parameter for said reflected reference pulses;
determining a distance measurement to said reference surface;
determining the distance measurement to the target surface based on said ratio and said distance measurement to said reference surface.

7. The method as claimed in claim 6, wherein said reference surface comprises a reflecting surface adapted to reflect at least a portion of the energy bursts from the emitter.

8. The method as claimed in claim 7, wherein said first measured parameter comprises the time between emission of the burst of energy and reception of the burst of energy reflected by the target surface.

9. The method as claimed in claim 8, wherein said second measured parameter comprises the time between emission of the burst of energy and reception of the burst of energy reflected by said reference surface.

10. The method as claimed in claim 6, wherein said first measured parameter comprises the time between emission of the burst of energy and reception of the burst of energy reflected by the target surface.

11. The method as claimed in claim 10, wherein said second measured parameter comprises the time between emission of the burst of energy and reception of the burst of energy reflected by said reference surface.

12. An apparatus for performing level measurements of a material contained a vessel and having a surface, the apparatus comprises:
a transducer for emitting pulses towards to the surface of the material contained in the vessel and detecting echo pulses reflected by the to surface of the material;
a transmitter coupled to said transducer, said transmitter being responsive to transmit control signals for controlling emission of pulses from said transducer;
a receiver coupled to said transducer, said receiver converting the reflected pulses received by said transducer into electrical signals corresponding to said received reflected pulses;
a controller, said controller being operatively coupled to said transmitter and having a program component for generating said transmit control signals, and said controller being operatively coupled to said receiver and having a program component for receiving and processing the electrical signals from said receiver;
a reference reflector, said reference reflector being positioned to reflect one or more of said emitted pulses back to said transducer to provide one or more reference pulses, and said reference reflector being located at a known distance from said transducer;
said controller including a program component for determining a measured parameter associated with one or more of said echo pulses and for determining another measured parameter associated with one or more of said reference pulses, and a program component for determining a ratio comprising said measured parameters;
said controller including a program component for determining a distance measurement to the surface of the material based on said ratio and the known distance to said reference reflector.

13. The apparatus as claimed in claim 12, wherein said reference reflector comprises a reflecting ring.

14. The apparatus as claimed in claim 12, wherein said measured parameter comprises the time between the emission of said pulses and the reception of said pulses reflected by the surface.

15. The apparatus as claimed in claim 14, wherein said other measured parameter comprises the time between the emission of said pulses and the reception of said reference pulses.

16. The apparatus as claimed in claim 15, wherein said program component for determining a distance measurement executes an equation given by:
D_{TARGET}=D_{REF}*(T_{TARGET}/T_{REF}),
Where:
D_{TARGET} is the distance from said transducer to the surface of the material.
D_{REF} is the distance to said reference reflector,
T_{TARGET} is the time measured between the transmission and reception of the pulse reflected by said reference reflector and corresponds to said measured parameter,
T_{REF} is the time measured between the transmission and reception of the pulses reflected by said reference reflector and corresponds to said other measured parameter.

17. The apparatus as claimed in claim 16, wherein said reference reflector comprises a reflective surface, and includes a cone for focusing said reflected pulses towards said transducer.

18. The apparatus as claimed in claim 16, wherein said reference reflector comprises a distant end of said transducer, and said controller includes a program component for determining said reference pulse from one of said echo pulses received at the distant end of said transducer.

19. A level measurement apparatus for determining a distance measurement to a surface, said apparatus comprising:
means for emitting one or more pulses towards the surface;
means for receiving reflected pulses from the surface, and means for determining a first measured parameter for at least one of said reflected pulses;
means for receiving one or more pulses reflected by a reference surface means, and means for determining a second measured parameter for at least one of said reflected reference pulses;
means for forming a ratio between said first measured parameter for said reflected pulses and said second measured parameter for said reflected reference pulses;
means for determining a distance measurement to said reference surface means;
means for calculating the distance measurement to the surface based on said ratio and said distance measurement to said reference surface means.

20. The apparatus as claimed in claim 19, wherein said means for calculating executes an equation as follows:
D_{TARGET}=D_{REF}*(T_{TARGET}/T_{REF}),
Where,
D_{TARGET} is the distance from said means for emitting to the surface of the material,
D_{REF} is the distance to said reference surface means,
T_{TARGET} IS the time measured between the transmission and reception of the pulses reflected by said surface,
T_{REF} is the time measured between the transmission and reception of the pulses reflected by said reference surface means.
